(19) United States
(12) Patent Application Publication
(10) Pub. No.: US 2008/0308206 A1
(43) Pub. Date: Dec. 18, 2008

(54) WHEEL UNIT

(75) Inventor: SATORU OKADA, Gifu-ken (JP)

Correspondence Address: FULWIDER PATTON LLP, HOWARD HUGHES CENTER, 6060 CENTER DRIVE, TENTH FLOOR, LOS ANGELES, CA, 90045, US

(73) Assignee: PACIFIC INDUSTRIAL CO., LTD., Ogaki-shi (JP)

(21) Appl. No.: 11/864,889

(22) Filed: Sep. 28, 2007

(30) Foreign Application Priority Data
Jun. 15, 2007 (JP) 2007-159015

(51) Int. Cl. B60C 23/12

(52) U.S. Cl. 152/419

(57) ABSTRACT

A wheel unit includes a wheel and a pressure adjusting device installed on the wheel to adjust the pressure in the tire. The pressure adjusting device includes a cylinder and a piston provided in the cylinder. The piston moves in the cylinder by centrifugal force generated by rotation of the wheel so that air introduced into the cylinder from the outside is injected to an internal space of the tire. The wheel includes a mounting hole, which extends in the radial direction of the wheel and opens to the internal space of the tire. The pressure adjusting device is installed in the mounting hole such that the moving direction of the piston agrees with the radial direction of the wheel and that the pressure adjusting device is not exposed to the outside from an outer surface of the wheel except in the internal space of the tire.

### BACKGROUND OF THE INVENTION

The present invention relates to a wheel unit.

A pressure adjusting device has been proposed that is provided on a wheel of a vehicle such as an automobile, and that automatically adjusts the pressure in a tire mounted on the wheel. Japanese Laid-Open Patent Publication No. 2003-341320 and Japanese Laid-Open Patent Publication No. 2004-330820 each disclose a pressure adjusting device, which includes a cylinder connected to an internal space of a tire. The pressure adjusting device supplies air drawn into the cylinder from the atmosphere to the inside of the tire by moving a piston in the cylinder using centrifugal force generated by rotation of the tire.

However, the pressure adjusting device disclosed in the above publications No. 2003-341320 and No. 2004-330820 is mounted on a wheel so as to be exposed to the outside. Thus, while driving the vehicle, an object such as a pebble easily hits the device. As a result, the device might be damaged.

### SUMMARY OF THE INVENTION

Accordingly, it is an objective of the present invention to provide a wheel unit including a pressure adjusting device that is unlikely to be damaged.

To achieve the above objective, and in accordance with one aspect of the present invention, a wheel unit, which includes a wheel, on which a tire is mounted, and a pressure adjusting device installed on the wheel to adjust the pressure in the tire is provided. The pressure adjusting device includes a cylinder and a piston provided in the cylinder. When the piston moves in the cylinder by centrifugal force generated by rotation of the wheel, air introduced into the cylinder from the outside is injected to an internal space of the tire. The wheel includes a hole, which extends in the radial direction of the wheel and opens to the internal space of the tire. The pressure adjusting device is installed in the hole such that the moving direction of the piston agrees with the radial direction of the wheel and that the pressure adjusting device is not exposed to the outside from an outer surface of the wheel except in the internal space of the tire.

According to this, the pressure adjusting device is installed on the wheel so as not to be exposed to the outside from the outer surface of the wheel except in the internal space of the tire. This reduces the possibility of damage on the pressure adjusting device by impact of a pebble and the like.

The wheel preferably includes a communication passage, which connects the cylinder to the outside to introduce outside air to the inside of the cylinder. The communication passage may extend from the end connected to the cylinder in a radially outward direction of the wheel and may open in the outer surface of the wheel.

According to this, since the communication passage extends from the end connected to the cylinder in a radially outward direction of the wheel and opens in the outer surface of the wheel, when the wheel is rotated as the automobile travels, water such as rainwater that has entered the communication passage is discharged from the outer surface of the wheel through the communication passage by centrifugal force generated by the rotation of the wheel unit. Thus, water such as rainwater does not enter the pressure adjusting device.

The piston preferably divides an internal space of the cylinder into a first chamber, which communicates with the communication passage, and a second chamber, which is selectively connected to the internal space of the tire. The piston includes an internal passage, which is selectively connected to the first chamber and communicates with the second chamber. The pressure adjusting device may include a first check valve and a second check valve. The first check valve permits air to flow from the first chamber to the internal passage and prevents air from flowing from the internal passage to the first chamber. The second check valve permits air to flow from the second chamber to the internal space of the tire and prevents air from flowing from the internal space of the tire to the second chamber.

According to this, since the first check valve prevents air from flowing from the internal passage to the first chamber when the piston moves to reduce the volume of the second chamber, the pressure in the second chamber is increased. At this time, since the second check valve permits air to flow from the second chamber to the internal space of the tire, the air compressed in the second chamber is injected to the internal space of the tire. When the piston moves to increase the volume of the second chamber, the second check valve prevents air from flowing from the internal space of the tire to the second chamber. This prevents air in the internal space of the tire from flowing to the outside through the cylinder. Thus, the pressure in the internal space of the tire is maintained.

At least one of the first check valve and the second check valve may preferably be an umbrella valve.

According to this, the first check valve and the second check valve have simple configurations. Also, the size of the pressure adjusting device is reduced.

The piston may preferably receive force to move in a direction to reduce the volume of the second chamber by centrifugal force generated by rotation of the wheel.

According to this, when the wheel is rotated, the piston receives centrifugal force generated by the rotation of the wheel, and the piston moves to reduce the volume of the second chamber. Therefore, air in the second chamber is compressed and injected to the internal space of the tire. Furthermore, when centrifugal force is not acting on the piston, the second check valve prevents air from flowing from the internal space of the tire to the second chamber. Thus, the pressure in the internal space of the tire is maintained.

The pressure adjusting device may preferably include an urging member, which urges the piston in a direction to increase the volume of the second chamber.

According to this, when the tire is not rotating, and centrifugal force is not applied to the piston, the piston maintains the volume of the second chamber at the maximum. Therefore, when the tire rotates, the air in the second chamber is compressed to a sufficient pressure. Thus, air is reliably injected to the inside of the tire.

A filter, which prevents water from flowing therethrough and permits air to flow therethrough, may preferably be provided between the communication passage and the first chamber.

According to this, since water does not flow into the cylinder, the cylinder is not deteriorated by water. As a result, the life of the pressure adjusting device is extended.

A sealing member may preferably be provided between an outer circumferential wall of the piston and an inner circumferential wall of the cylinder.

According to this, air in the internal space of the tire does not leak outside through a gap between the outer circumferential wall of the piston and the inner circumferential wall of the cylinder when the piston moves. Thus, air is reliably injected to the inside of the tire.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram illustrating a wheel unit according to the present invention;

FIG. 2 is a schematic diagram illustrating a state where a pressure adjusting device, which forms the wheel unit of FIG. 1, is mounted on the wheel;

FIG. 3 is a cross-sectional view illustrating the configuration of the pressure adjusting device of FIG. 2;

FIG. 4 is a diagram for explaining the operation of the pressure adjusting device when the wheel unit is stopped or rotating at a low speed; and

FIG. 5 is a diagram for explaining the operation of the pressure adjusting device when the wheel unit is rotating at a high speed.

### DETAILED DESCRIPTION OF THE PREFERRED EMBODIMENT

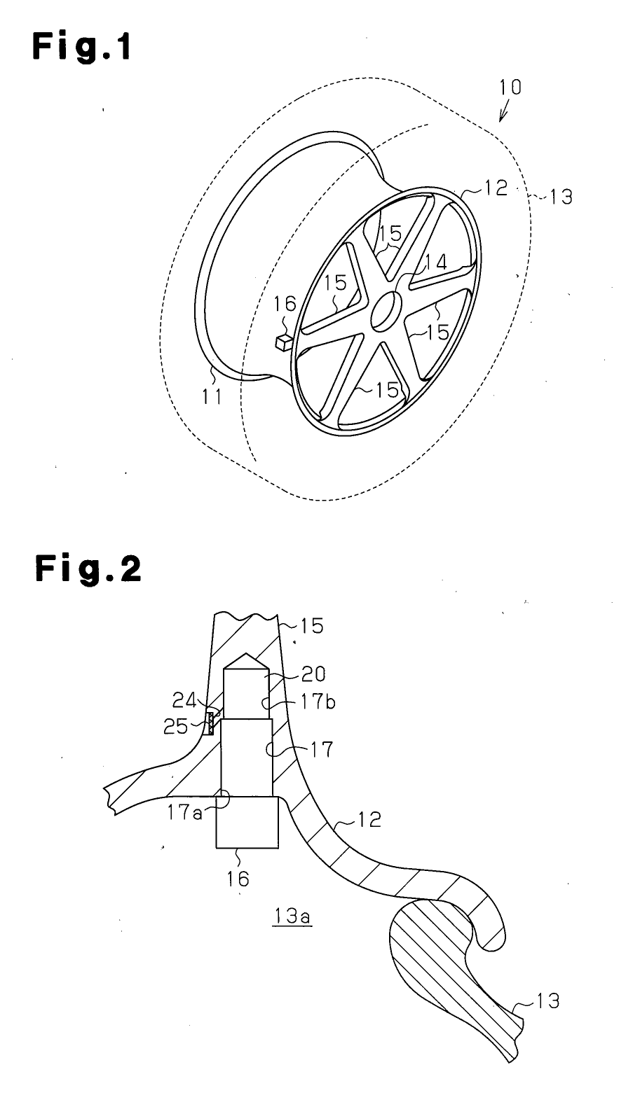

One embodiment of the present invention will now be described with reference to FIGS. 1 to 5.

FIG. 1 shows one of wheels 11 mounted on an automobile, a tire 13 mounted on the wheel 11, and a pressure adjusting device 16 installed on the wheel 11. The wheel 11 and the pressure adjusting device 16 form a wheel unit 10. The wheel 11 includes an annular rim 12 and six spokes 15, which radially extend from a rotation axis 14 of the tire 13 to the rim 12. The pressure adjusting device 16 is embedded in the wheel 11 at a position corresponding to one of the six spokes 15. In FIG. 1, the tire 13 is shown by a broken line to clearly show the mounting position of the pressure adjusting device 16.

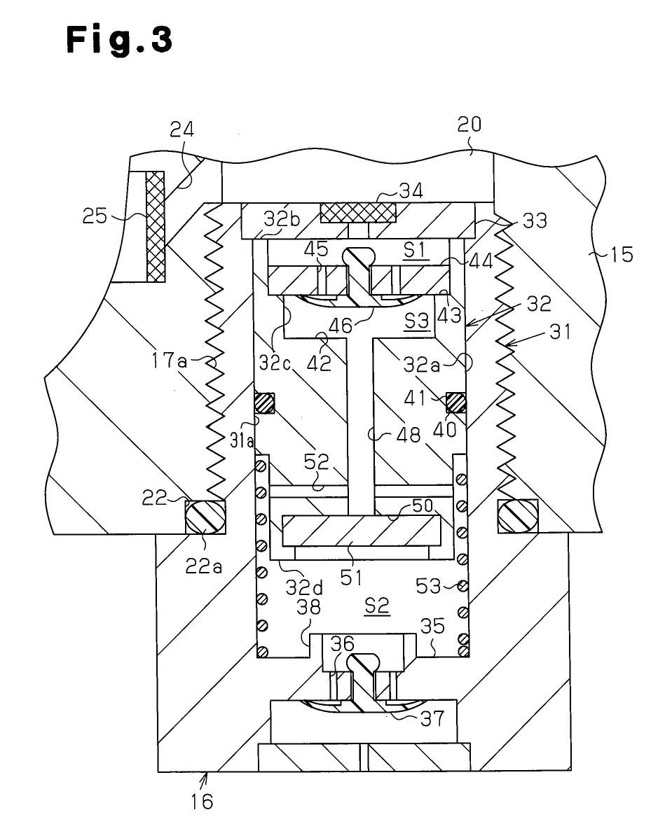

More specifically, as shown in FIG. 2, one of the spokes 15 has a cylindrical hole, which extends through the rim 12 and is connected to an internal space 13a of the tire 13. The cylindrical hole is a mounting hole 17 in this embodiment. The hole 17 extends in the radial direction of the wheel 11, that is, in the longitudinal direction of the associated spoke 15, and includes a first hole portion 17a, which opens in the outer circumferential surface of the rim 12 to be connected to the internal space 13a of the tire 13, and a second hole portion 17b, which is connected to the first hole portion 17a. An internal thread is formed on the inner circumferential surface of the first hole portion 17a and an external thread is formed on the outer circumferential surface of the pressure adjusting device 16. The pressure adjusting device 16 is screwed to the first hole portion 17a. This secures the pressure adjusting device 16 to the rim 12. Part of the pressure adjusting device 16 protrudes from the outer circumferential surface of the rim 12, and is exposed to the internal space 13a of the tire 13. As shown in FIG. 3, an annular groove 22 is formed in the opening rim of the first hole portion 17a. The rim 12 and the pressure adjusting device 16 are held airtight by a sealing ring 22a fitted in the groove 22.

As shown in FIG. 2, the second hole portion 17b forms a reservoir 20, which stores air introduced into the pressure adjusting device 16.

The spoke 15 is provided with a communication passage 24, which is connected to the reservoir 20 (second hole portion 17b). The communication passage 24 extends diagonally with respect to the radial direction of the wheel 11 (longitudinal direction of the spoke 15). The communication passage 24 extends radially outward of the wheel 11 from the reservoir 20, and is open in the outer surface of the spoke 15. The outside air is introduced into the reservoir 20 through the communication passage 24. Water such as rainwater might enter the reservoir 20 through the communication passage 24. However, the water that has entered the reservoir 20 is discharged outside through the communication passage 24, which extends radially outward, by centrifugal force generated when the wheel 11 rotates as the automobile travels.

A first filter 25 is attached to the opening of the communication passage 24 to the outside. The first filter 25 prevents foreign objects from entering the reservoir 20.

The configuration of the pressure adjusting device 16 will now be described with reference to FIG. 3.

The pressure adjusting device 16 includes a cylinder 31 (housing) and a piston 32, which is located in the cylinder 31. The moving direction of the piston 32 agrees with the longitudinal direction of the spoke 15, that is, the radial direction of the wheel 11. The piston 32 moves in the cylinder 31 by centrifugal force generated by rotation of the wheel unit 10.

A filter holder 33 is attached to the distal opening of the cylinder 31. The filter holder 33 retains a second filter 34. The second filter 34 prevents not only solid foreign objects but also water from passing therethrough. Thus, clean air flows into the cylinder 31 from the reservoir 20 through the second filter 34.

A passage 36, which connects an internal space of the cylinder 31 to the internal space 13a of the tire 13, is formed in a partition 35 provided at the proximal end of the cylinder 31. A second check valve, which selectively opens and closes the passage 36, is attached to the partition 35. The second check valve is a first umbrella valve 37 in this embodiment. The first umbrella valve 37 is a known member and functions as a check valve that prevents air from flowing from the internal space 13a of the tire 13 to the inside of the cylinder 31 (more specifically, a second chamber S2, which will be described below). The first umbrella valve 37 opens the passage 36 when the pressure in the cylinder 31 is greater than the pressure in the internal space 13a of the tire 13, and permits air to flow from the inside of the cylinder 31 to the internal space 13a of the tire 13. Also, the first umbrella valve 37 closes the passage 36 when the pressure in the cylinder 31 is less than the pressure in the internal space 13a of the tire 13, and prevents air from flowing from the internal space 13a of the tire 13 to the inside of the cylinder 31.

The partition 35 has an annular protrusion 38, which is located around the first umbrella valve 37 and extends toward the internal space of the cylinder 31.

The piston 32 divides the internal space of the cylinder 31 into a first chamber S1 and a second chamber S2. The first chamber S1 communicates with the reservoir 20 via the filter 34. The second chamber S2 communicates with the internal space 13a of the tire 13 via the passage 36. The pressure in the first chamber S1 is substantially equal to the atmospheric pressure. An annular groove 40 is formed in the outer circumferential wall 32a of the piston 32. A sealing member, which is a sealing ring 41 in this embodiment, is fitted in the groove 40. The sealing ring 41 seals between the outer circumferential wall 32a of the piston 32 and the inner circumferential wall 31a of the cylinder 31.

A first recess 42 is formed in an end portion 32b of the piston 32, which end portion 32b is exposed in the first chamber SI. An annular step 43 is formed at the axially middle portion of the recess 42. A partition 44 is secured on the step 43. The partition 44 forms a third chamber S3, which is separate from the first chamber S1, in the recess 42. A through hole 45 is formed in the partition 44 so that the first chamber S1 communicates with the third chamber S3.

A first check valve for selectively opening and closing the through hole 45 is attached to the partition 44. The first check valve is the second umbrella valve 46 in this embodiment. The second umbrella valve 46 closes the through hole 45 when the pressure in the third chamber S3 is greater than the pressure in the first chamber S1, and prevents air from flowing from the third chamber S3 to the first chamber S1. Also, the second umbrella valve 46 opens the through hole 45 when the pressure in the third chamber S3 is less than the pressure in the first chamber S1, and permits air to flow from the first chamber S1 to the third chamber S3.

An axial hole 48, which communicates with the third chamber S3, is formed inside the piston 32. The axial hole 48 communicates with the second chamber S2 via a radial bore 52 formed in the piston 32. The third chamber S3, the axial hole 48, and the radial bore 52 form an internal passage, which is selectively connected to the first chamber S1 and communicates with the second chamber S2.

A second recess 50 is formed in an end portion 32d of the piston 32, which end portion 32d is exposed in the second chamber S2. An abutment member 51, which selectively abuts against the protrusion 38, is fitted in the recess 50. When the abutment member 51 abuts against the protrusion 38, the movement of the piston 32 is restricted in a direction radially outward of the wheel 11 (downward in FIG. 3), that is, in a direction to reduce the volume of the second chamber S2.

An urging member for urging the piston 32 toward the first chamber S1 is arranged between the piston 32 and the bottom of the internal space of the cylinder 31. The urging member is a coil spring 53 in this embodiment. The spring constant of the spring 53 is set to a value at which the spring 53 contracts by centrifugal force applied to the piston 32 when the automobile travels at a speed over 50 Km/h. That is, the piston 32 receives force to move in a direction to reduce the volume of the second chamber S2 by centrifugal force generated by rotation of the wheel unit 10. When the traveling speed of the automobile is in a range from 0 Km/h to 50 Km/h, the spring 53 is not contracted by the piston 32. As a result, the volume of the second chamber S2 is maintained at the maximum. When the automobile travels at a speed over 50 Km/h, the piston 32 moves so as to reduce the volume of the second chamber S2 while contracting the spring 53 by centrifugal force, thereby increasing the pressure in the second chamber S2.

Next, the operation of the wheel unit 10 will be described.

As shown in FIG. 2, the hole 17, which extends in the radial direction of the wheel 11 and opens to the internal space 13a of the tire 13, is formed in the wheel 11. The pressure adjusting device 16 is mounted in the hole 17 so as to be embedded in the wheel 11. Part of the pressure adjusting device 16 is exposed in the internal space 13a of the tire 13. Thus, the pressure adjusting device 16 is mounted on the wheel 11 such that the pressure adjusting device 16 is not exposed to the outside of the outer surface of the wheel 11 except in the internal space 13a of the tire 13. Therefore, foreign objects such as a pebble does not hit the pressure adjusting device 16. Thus, the possibility of damage on the pressure adjusting device 16 is reduced.

Furthermore, although the communication passage 24 for introducing air into the reservoir 20 is open in the outer surface of the wheel 11, since the first filter 25 is mounted in the opening of the communication passage 24, air from which foreign objects are removed is introduced into the reservoir 20. Moreover, since the communication passage 24 extends from the end connected to the reservoir 20 to a radially outward direction of the wheel 11, even if water enters the reservoir 20, the water that has entered the reservoir 20 is automatically discharged outside through the communication passage 24 by centrifugal force generated when the wheel 11 rotates as the automobile travels.

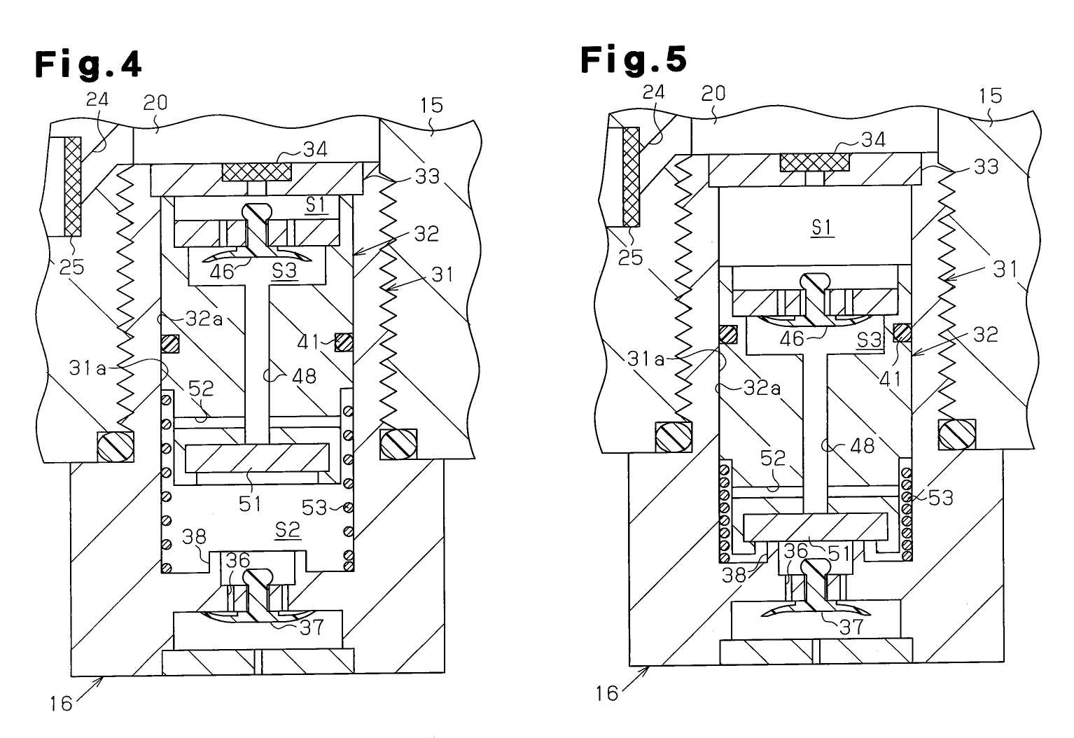

In the pressure adjusting device 16, the piston 32 is urged by the coil spring 53 in a direction opposite to the direction of centrifugal force applied to the piston 32 when the wheel unit 10 is rotated. Therefore, when the automobile is stopped and the wheel unit 10 is not rotated, the piston 32 minimizes the volume of the first chamber S1 by the force of the coil spring 53, and maximizes the volume of the second chamber S2 as shown in FIG. 4. At this time, since the pressure in the second chamber S2 and the internal passage of the piston 32 are substantially the same, the first umbrella valve 37 closes the passage 36.

When the automobile starts moving and the wheel unit 10 rotates, centrifugal force acts on the piston 32. When the rotation speed of the wheel unit 10 is increased, and the automobile travels at a speed over 50 Km/h, the piston 32 moves to reduce the volume of the second chamber S2 against the force of the coil spring 53.

As the volume of the second chamber S2 is reduced in accordance with the movement of the piston 32, the pressure in the second chamber S2 is gradually increased. At this time, the second umbrella valve 46 is maintained in a state of closing the through hole 45. Also, the pressure adjusting device 16 is configured such that the pressure in the second chamber S2 reaches a reference pressure when the piston 32 moves until the abutment member 51 abuts against the protrusion 38 in a state where the first umbrella valve 37 closes the passage 36. Therefore, when the pressure in the internal space 13a of the tire 13 is maintained at the reference pressure, the first umbrella valve 37 does not open even if the piston 32 is moved by the centrifugal force until the piston 32 abuts against the protrusion 38. Thus, air is not introduced from the second chamber S2 to the internal space 13a of the tire 13. However, when the pressure in the internal space 13a of the tire 13 is lower than the reference pressure, the first umbrella valve 37 opens while the piston 32 is moved by the centrifugal force. Thus, the air in the second chamber S2 enters the internal space 13a of the tire 13 through the passage 36 (see FIG. 5). As a result, the pressure in the internal space 13a of the tire 13 is increased. The reference pressure is a pressure value of a tire that is appropriate when the automobile is traveling.

Since the sealing ring 41 seals between the outer circumferential wall 32a of the piston 32 and the inner circumferential wall 31a of the cylinder 31, air does not flow between the outer circumferential wall 32a of the piston 32 and the inner circumferential wall 31a of the cylinder 31 when the piston 32 moves. Therefore, when the piston 32 moves by the centrifugal force, the pressure in the second chamber S2 is reliably increased until the pressure reaches the reference pressure.

When the rotation speed of the wheel unit 10 is reduced in accordance with deceleration of the automobile, the centrifugal force that acts on the piston 32 is reduced. When the traveling speed of the automobile becomes lower than 50 Km/h, the piston 32 moves in a direction to increase the volume of the second chamber S2 by the force of the coil spring 53.

As the volume of the second chamber S2 is increased in accordance with the movement of the piston 32, the pressure in the second chamber S2 is reduced. During the movement of the piston 32, when the pressure in the second chamber S2 becomes lower than the pressure in the internal space 13a of the tire 13, the first umbrella valve 37 is closed. Also, during the movement of the piston 32, when the pressure in the second chamber S2 becomes lower than the pressure in the first chamber S1 (atmospheric pressure), the second umbrella valve 46 opens, and air is introduced into the second chamber S2 from the first chamber S1 (see FIG. 4). Then, when the piston 32 abuts against the filter holder 33 as shown in FIG. 3, the volume of the second chamber S2 is maximized.

Thereafter, when the automobile travels at a speed over 50 Km/h again, the piston 32 is moved by the centrifugal force to increase the pressure in the second chamber S2, and air is injected into the internal space 13a of the tire 13 from the second chamber S2 as required. As a result, the pressure in the internal space 13a of the tire 13 is maintained at the reference pressure.

The preferred embodiment has the following advantages.. (1) The cylindrical mounting hole 17, which extends through the rim 12 and is connected to the internal space 13a of the tire 13, is formed in one of the spokes 15 of the wheel 11. The pressure adjusting device 16 is secured to the hole 17. Thus, since the pressure adjusting device 16 is not exposed to the outside, foreign objects such as a pebble does not hit the pressure adjusting device 16. As a result, the possibility of damage on the pressure adjusting device 16 by impact of a pebble is reduced. (2) The communication passage 24 is formed in the wheel 11 to introduce the outside air into the cylinder 31. The communication passage 24 extends from the reservoir 20, which is connected to the cylinder 31, in a radially outward direction of the wheel 11, and opens in the outer surface of the wheel 11. Thus, when water such as rainwater enters the communication passage 24 when raining, the water is discharged outside through the communication passage 24 by centrifugal force generated as the wheel unit 10 is rotated. As a result, air from which dust and water are removed is introduced into the pressure adjusting device 16. (3) The first filter 25 is mounted in the opening of the communication passage 24 to the outside. Thus, foreign objects are prevented from entering the reservoir 20. (4) The piston 32 divides the internal space of the cylinder 31 into the first chamber S1, which communicates with the communication passage 24, and the second chamber S2, which is selectively connected to the internal space 13a of the tire 13. The axial hole 48, which is selectively connected to the first chamber S1 and communicates with the second chamber S2, is formed in the piston 32. The pressure adjusting device 16 is provided with the second umbrella valve 46, which permits air to flow from the first chamber S1 to the axial hole 48 and prevents air from flowing from the axial hole 48 to the first chamber S1, and the first umbrella valve 37, which permits air to flow from the second chamber S2 to the internal space 13a of the tire 13 and prevents air from flowing from the internal space 13a of the tire 13 to the second chamber S2. Therefore, since the piston 32 compresses the air in the second chamber S2 when the wheel 11 is rotated, and the compressed air is injected to the internal space 13a of the tire 13, the pressure in the internal space 13a of the tire 13 does not decrease. Also, since the second umbrella valve 46 and the first umbrella valve 37 are used as check valves, and thus the configuration is simple as compared to a check valve having other mechanism, the size of the pressure adjusting device 16 is reduced. (5) The coil spring 53 urges the piston 32 in a direction to increase the volume of the second chamber S2. Therefore, when centrifugal force is not applied to the piston 32, the piston 32 moves toward the first chamber S1, thereby maintaining the volume of the second chamber S2 at the maximum. As a result, the pressure of the air in the second chamber S2 can be sufficiently increased. Thus, air is reliably injected to the internal space 13a of the tire 13. (6) The second filter 34 is provided between the reservoir 20 and the first chamber S1 to prevent not only solid foreign objects but also water from passing through. Therefore, since clean air flows into the inside of the cylinder 31 from the reservoir 20 through the second filter 34, the life of the pressure adjusting device 16 is extended. (7) The annular groove 40 is formed in the outer circumferential wall 32a of the piston 32. Since the sealing ring 41 is fitted in the groove 40, the inner circumferential wall 31a of the cylinder 31 and the outer circumferential wall 32a of the piston 32 are sealed. Thus, since air does not leak to the outside when the piston 32 moves, the pressure in the second chamber S2 is reliably increased.

The present invention is not limited to the above embodiment, but may be modified as follows.

Instead of the umbrella valves 37, 46, check valves having other forms may be used.

The wheel unit 10 of the present invention may be applied to vehicles other than automobiles.

Instead of the coil spring 53, an elastic member that easily expand and contract may be used.

Instead of using the sealing ring 41 as the sealing member, sealing member such as a gasket may be used.

Instead of providing the sealing ring 41 on the outer circumferential wall 32a of the piston 32 as the sealing member, the sealing ring 41 may be provided on the inner circumferential wall 31a of the cylinder 31.

What is claimed is:

1. A wheel unit comprising: a wheel, on which a tire is mounted; and a pressure adjusting device installed on the wheel to adjust the pressure in the tire,
wherein the pressure adjusting device includes a cylinder and a piston provided in the cylinder, when the piston moves in the cylinder by centrifugal force generated by rotation of the wheel, air introduced into the cylinder from the outside is injected to an internal space of the tire,
wherein the wheel includes a hole, which extends in the radial direction of the wheel and opens to the internal space of the tire, and
wherein the pressure adjusting device is installed in the hole such that the moving direction of the piston agrees with the radial direction of the wheel and that the pressure adjusting device is not exposed to the outside from an outer surface of the wheel except in the internal space of the tire.

2. The wheel unit according to claim 1, wherein the wheel includes a communication passage, which connects the cylinder to the outside to introduce outside air to the inside of the cylinder, and
wherein the communication passage extends from the end connected to the cylinder in a radially outward direction of the wheel and opens in the outer surface of the wheel.

3. The wheel unit according to claim 2, wherein the piston divides an internal space of the cylinder into a first chamber, which communicates with the communication passage, and a second chamber, which is selectively connected to the internal space of the tire, the piston including an internal passage, which is selectively connected to the first chamber and communicates with the second chamber,
wherein the pressure adjusting device includes:
a first check valve, which permits air to flow from the first chamber to the internal passage and prevents air from flowing from the internal passage to the first chamber; and
a second check valve, which permits air to flow from the second chamber to the internal space of the tire and prevents air from flowing from the internal space of the tire to the second chamber.

4. The wheel unit according to claim 3, wherein at least one of the first check valve and the second check valve is an umbrella valve.

5. The wheel unit according to claim 3, wherein the piston receives force to move in a direction to reduce the volume of the second chamber by centrifugal force generated by rotation of the wheel.

6. The wheel unit according to claim 5, wherein the pressure adjusting device includes an urging member, which urges the piston in a direction to increase the volume of the second chamber.

7. The wheel unit according to claim 3, wherein a filter is provided between the communication passage and the first chamber, the filter preventing water from flowing therethrough and permitting air to flow therethrough.

8. The wheel unit according to claim 1, wherein a sealing member is provided between an outer circumferential wall of the piston and an inner circumferential wall of the cylinder.
